(19) United States
(12) Patent Application Publication
(10) Pub. No.: US 2004/0228990 A1
(43) Pub. Date: Nov. 18, 2004

(54) Protective packaging system

(76) Inventor: Vernon A Hines, Auckland (NZ)

Correspondence Address: DARBY & DARBY P.C., P. O. BOX 5257, NEW YORK, NY, 10150-5257, US

(21) Appl. No.: 10/487,502

(22) PCT Filed: Aug. 21, 2002
(86) PCT No.: PCT/NZ02/00159

(30) Foreign Application Priority Data
Aug. 22, 2001 (NZ) 513660
Jun. 5, 2002 (NZ) 519331

(51) Int. Cl. F16L 1/00

(52) U.S. Cl. 428/34.1

(57) ABSTRACT

A protective packaging system (1) which includes a strip of protective material (2) adapted to form a plurality of internal activities (6). Preferably, a single adhesive strip bandage (5) is packaged within each of these internal cavities which provides a sterile, airtight and waterproof environment.

### TECHNICAL FIELD

This invention relates to the provision of a protective packaging system and a method of using same to easily dispense packaged articles. Preferably the present invention may be adapted to package adhesive strip type bandages for small wounds in a sterile environment, and allow these bandages to be dispensed easily and quickly. Reference throughout this specification win also be made to the present invention being used in this application but those skilled in the art should appreciate that other uses are also envisioned and reference to the above should in no way be seen as limiting.

### BACKGROUND ART

Some types of products or articles need to be packaged in a protective enclosure. For example, in the case of medical supplies or bandages the article in question needs to be stored in a sterile environment to ensure that it does not cause additional health problems when employed.

Adhesive strip type bandages are commonly used by consumers to dress small wounds, with the adhesive of the bandage holding it in place on the wound. Packaging used with these types of bandages necessarily must both preserve the bonding qualities of the adhesive and also keep the dressing portion of the strip within a sterile environment.

The existing packaging approach employed with these types of bandages is to seal each bandage within its own individual flexible housing. Normally the housing employed forms a plastic or paper pouch that is sealed around the bandage to create an airtight and sterile enclosure.

As these protective pouches need to be fully sealed, and can cause difficulties for users wishing to open them in a hurry to dress a fresh wound. Some users find this type of packaging fiddly to handle and time consuming to open, especially when they are trying to give first aid.

Some forms of adhesive based bandage also employ protective pads to cover the adhesive portions of the bandage. Again a user must remove these protective pads before they can dress a wound with the bandage. This further complicates and slows down bandage extraction and application.

An improved packaging system which addressed any or all of the above problems would be of advantage. An improved packaging system which allowed bandages to be dispensed using limited manual dexterity and which still protected the stored bandages in a sterile environment would be of advantage.

It is an object of the present invention to address the foregoing problems or at least to provide the public with a useful choice.

Further aspects and advantages of the present invention will become apparent from the ensuing description that is given by way of example only.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a protective packaging system which includes,

a strip of protective material adapted to form a plurality of internal cavities, said cavities being used to house articles to be packaged.

According to a further aspect of the present invention there is provided a protective packaging system substantially as described above wherein the strip is formed from an upper length and a lower length bonded together at selected areas to form the plurality of internal cavities.

According to a further aspect of the present invention there is provided a protective packaging system substantially as described above wherein a single bandage is packaged within each internal cavity of the strip of protective material.

According to another aspect of the present invention there is provided protective packaging system substantially as described above where the strip is wound into a roll located within a dispensing box, the dispensing box being formed so that extraction of the strip from the box will cause the internal cavities of the strip to be opened.

According to yet another aspect of the present invention there is provided a wound dressing system which includes,

a protective packaging system substantially as described above, and

a bandage located within each of the internal cavities of the packaging system strip.

The present invention is adapted to provide a protective packaging system for a number of different types of articles. Such a packaging system may allow the articles packaged to be stored in a suitable environment and also preferably to be transported in large volumes or quantities relatively easily. Preferably the protective packaging system provided may enclose or protect the packaged articles within internal cavities which provide an airtight and/or sterile environment.

In a further preferred embodiment the present invention may be implemented within a wound dressing system which is adapted to store bandages using the protective packaging system substantially as described above. Such a wound dressing system will ensure that the dressings or bandages involved are stored within a sterile environment before use and that such bandages can also be easily dispensed or accessed quickly be a user.

Reference throughout this specification will also be made to a packaging system formed in accordance with the present invention being used to package bandages. Furthermore, such bandages will be referred to as adhesive strip bandages which are held in place adjacent to a wound by a layer or coating or adhesive. However, those skilled in the art should appreciate that other types of articles or even other types of bandages may also be packaged using the present invention and reference to the above only throughout this specification should in no way be seen as limiting.

Preferably the present invention employs a strip of protective material to house or package a number of adhesive strip bandages, with a bandage in each internal cavity of the strip. This strip of protective material may preferably fully enclose all of the bandages to be packaged.

In a further preferred embodiment the protective material may be formed from one or more lengths of plastics film, or from one or more lengths of paper material. Preferably, such materials may also be coated with or include an additive to give the resulting strip qualities not present in the base material used. In one preferred embodiment, an additive may be included to improve the protective material's impermeability to gas or fluid. In alternative embodiments, the additive included may provide a sterilising compound to kill any viruses, bacteria or micro-organisms present within an internal cavity of the protective strip.

For example, in one instance the strip may be formed from paper material which has been wax or plastic coated to make the strip impermeable to air and also to give it a degree of water resistance.

Reference throughout this specification will also be made to the strip employed being formed from at least one length of protective plastic film. However, those skilled in the art should appreciate that other forms of protective material which exhibit the required material characteristics may also be employed in conjunction with the present invention. Reference to the above only throughout this specification should in no way be seen as limiting.

In a preferred embodiment the strip of protective material employed may form or define a series of internal cavities along its length. Each of the plurality of cavities formed may be adapted to enclose, house and protect at least one bandage or article to be packaged. The internal cavities provided in the strip may fully enclose the bandages to be packaged within an airtight and sterile environment.

In a further preferred embodiment a single bandage may be provided or packaged within each cavity of the strip. This configuration of the invention ensures that a user does not necessarily have to apply two or more bandages if they open a single internal cavity of the strip and therefore expose the bandages to a non-sterile environment.

In a preferred embodiment the strip may be formed from an upper length and a lower length between which the bandages to be packaged are sandwiched. The combination of the upper and lower lengths may form the strip of protective material required and the internal cavity that it defines. Each of the lengths provided may be formed from substantially the same protective material or materials and may be bonded together at selected points to form a plurality of internal cavities.

In a preferred embodiment the upper and lower lengths used to form the strip may be bonded together with use of an adhesive or glue. The adhesive chosen for this task may preferably provide an airtight and sterile barrier between the upper and lower lengths of the strip and may be applied to the inner surfaces of these lengths at selected areas to form the plurality of internal cavities required. Adhesive may be applied to the inner surfaces of each length along the sides of the lengths to seal the corresponding sides of the strip. A number of transverse applications of adhesive may also be made along the length of the strip to form a plurality of internal cavities.

Preferably the adhesive chosen to bond together the upper and lower lengths of the strip may also allow a user to separate the upper and lower lengths relatively easily when access to a bandage is required. Preferably the adhesive selected may allow the upper and lower lengths to be peeled away from each other when a force is applied by a user to gain quick access to a packaged bandage.

Reference throughout this specification will also be made to the upper and lower lengths of the strip being bonded together with an adhesive. However, those skilled in the art should appreciate that other forms of bonds or connections, such as for example heat seal bonds may also be employed within the present invention if required. Reference to the above only throughout this specification should in no way be seen as limiting.

Reference throughout this specification will also be made in the main to the upper and lower lengths of the strip formed from two substantially continuous lengths of material. However, those skilled in the art should appreciate that other configurations of the present invention are envisioned and reference to the above only throughout this specification should in no way be seen as limiting.

For example, in one potential alternative embodiment the lower strip may still be formed from a continuous length of material whereas the upper strip may be formed from a plurality of smaller, distinct or discreet portions of material with a portion placed over each bandage to be packaged. To gain access to a bandage a user simply needs to remove one of these pluralities of upper portions. In further preferred versions of this embodiment each discreet upper portion may be provided with a pull tab or protrusion at one of its sides or ends which is not fixed or connected to the lower strip. This tab may be grasped and pulled by a user to remove one of the upper portions from the lower length to easily access the bandage contained.

In a preferred embodiment the strip of protective material may be packaged within a dispensing box. Such a dispensing box may confine the protective strip within a relatively small volume and preferably (through extraction of the strip from the box) may be used to open at least one internal cavity of the strip to give a user access to a bandage.

In a further preferred embodiment the dispensing box may be employed to separate the upper and lower lengths of the protective material strip used to house bandages. The dispensing box may include a pair of outlet apertures through which the separated ends of the upper and lower length may be threaded. A user may pull on one or both of the separated ends to draw the strip out of the dispensing box and in turn open the internal cavities of the strip to gain access to a bandage.

Alternatively, a dispensing box used in conjunction with the present invention may include a single outlet aperture only. The box may also include an additional external channel formed from a folded over section of card, which allows one of the lengths to be threaded through same. By pulling on the length threaded through the additional channel the strip can be drawn out of the box and its internal cavities opened.

Preferably, and as discussed above the present invention may be used to package and dispense adhesive strip bandages. Such bandages are normally packaged with protective cover pads over the adhesive coated portions of the bandage.

In a further preferred embodiment where the present invention is used to package adhesive bandages, the adhesive coated portion of the bandage may be placed directly in contact with the surface of a cavity formed within the protective strip. This eliminates the need for protective cover pads to be applied to the adhesive bandage therefore speeding up the user's ability to obtain a bandage which may be used immediately.

In one embodiment the present invention may also include at least one handling tab for each bandage packaged. A handling tab may be sandwiched between one of the lengths of the protective strip and the bandage to separate an adhesive coated area of the bandage from the protective strip. Such a handling tag or tags may also protrude out past one side or edge of the bandage with respect to the handling strip, thereby allowing a user to grasp a tab and pull the adhesive coated bandage from one of the lengths of the protective strip employed.

This type of handling tab may also be used to assist in the placement of the bandage over a wound to be dressed. A user of the present invention need not necessarily touch adhesive coated portions of a bandage when dressing a wound and can also easily and quickly separate a bandage from the lower length of the protective strip using a handling tab. Such a handling tab may also preferably be removed from the adhesive coated portions of the bandage once it is located and placed on a wound to be dressed.

The present invention may provide many potential advantages over the prior art. By packaging a large number of bandages within the internal cavities of a strip a user of the invention can gain easy and quick access to bandages for first aid situations. The user needs only to separate the ends of the upper and lower lengths of the strip to open one or more internal cavities within the strip and therefore gain access to the bandages packaged.

Furthermore, a dispensing box may also be provided to at least in part automate this activity so that a user need only pull on one or both ends of the upper and lower lengths of the strip to open its internal cavities. In some instances the adhesive bandages may have their adhesive coated portions applied directly to the surface of an internal cavity. In such instances a user need only peel the bandage off the upper or lower layer of the strip to obtain a bandage ready for application.

This may be contrasted with prior art packaging systems which force the user to open an individual package for each bandage they require and to then remove adhesive protecting pads from the bandage before it can be used.

### BRIEF DESCRIPTION OF DRAWINGS

Further aspects of the present invention will become apparent from the ensuing description which is given by way of example only and with reference to the accompanying drawings in which:

FIG. 1a and 1b show top cross section and side exploded views of a protective packaging system formed in accordance with a preferred embodiment; and

FIG. 2 shows a wound dressing system constructed using the packaging system shown with respect to FIGS. 1a and 1b.

FIG. 3 shows a protective packaging system as formed in accordance with an alternative embodiment to that shown with respect to FIGS. 1a, 1b and 2.

FIGS. 4 and 5 show a top and exploded side view of a protective packaging system formed in accordance with yet another alternative embodiment for that shown with respect to FIGS. 1a, 1b, 2 and 3.

### BEST MODES FOR CARRYING OUT THE INVENTION

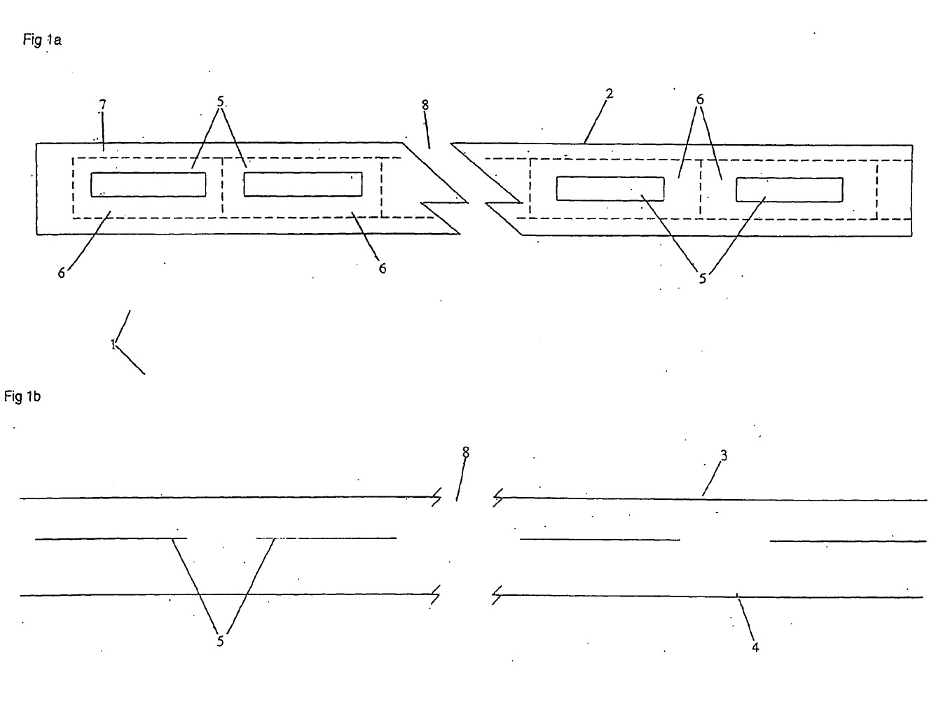

FIG. 1a shows a top cross section view of a protective packaging system 1 formed in accordance with a preferred embodiment of the present invention.

FIG. 1b shows a side cross section view of the same packaging system shown with respect to FIG. 1a.

In the embodiment shown the packaging system 1 includes a strip of protective material 2 formed by an upper length of material 3 and a lower length of material 4. Selected portions of the upper and lower lengths 3, 4 are bonded together to form the single strip of protective material 2.

In the embodiment shown the strip 2 is formed from a plastic material which is both airtight and waterproof. This type of material packages the articles involved within a sterile protective environment.

In the embodiment shown the protective strip 2 is used to package or enclose a number of adhesive bandages 5 within a plurality of internal cavities 6 formed within the strip. The adhesive bandages 5 are sandwiched between the upper and lower lengths 3, 4 used to make up the strip 2.

The internal cavities of the strip are formed by selected portions of the upper and lower lengths being bonded together on their inner sides. In the embodiment shown a pattern or deposit of adhesive 7 is applied to one or both of the inner surfaces of the lengths 3, 4. The pattern of adhesive applied bonds the two inner surfaces of the lengths together at selected areas to form the plurality of internal cavities 6 shown.

The strip 2 may be formed so as to package any number of adhesive strip bandages 5. The discontinuity 8 shown within the strip indicates that the length of the strip can vary depending on the number of bandages to be packaged.

The material selected to form the upper and lower lengths 3, 4 and also the adhesive used to bond selected areas of these lengths together is selected so as to ensure that each of the internal cavities formed creates a sterile protective environment for the bandage to be packaged. Each internal cavity is waterproof and airtight, eliminating the chances of pathogens or micro-organisms gaining access to and infecting the surface of the bandage before it is used.

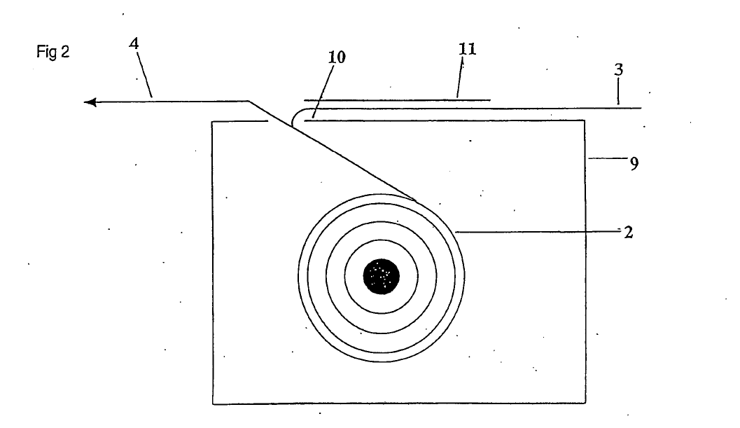

FIG. 2 shows a side cross section view of a wound dressing system which employs the protective packaging system discussed with respect to FIGS. 1a and 1b. In the instance shown the protective strip 2 still encloses a plurality of adhesive bandages between its upper and lower lengths 3, 4. The packaged bandages are dispensed or supplied to a user in conjunction with a dispensing box 9 which is used to house the protective strip 2. The strip 2 is wound into a tight roll of material to allow a large amount of the strip to be packaged within the relatively constrained volume of the dispensing box 9.

The dispensing box 9 also includes a single outlet aperture 10 through which the ends of the upper and lower lengths of the strip are fed. The box also includes an additional folded over “channel section” 11 through which the upper strip 3 may be threaded. This channel 11 diverges the upper and lower strips in opposite directions. A user of the invention shown can pull on either or both of the separated end lengths to open the internal cavities of the strip 2 and therefore gain access to the bandages packaged.

Furthermore, in some instances the adhesive coated portions of the bandage may be in direct contact with the lower length 4, which allows a user to simply peel the bandage off the lower length and apply it to a wound. This may be contrasted with prior art types of bandage packaging systems where a separate sealed package must be opened for each bandage and one or more protective covers must then be removed from the adhesive coated portions of the bandage, significantly complicating the actions required to access and use the bandage packaged.

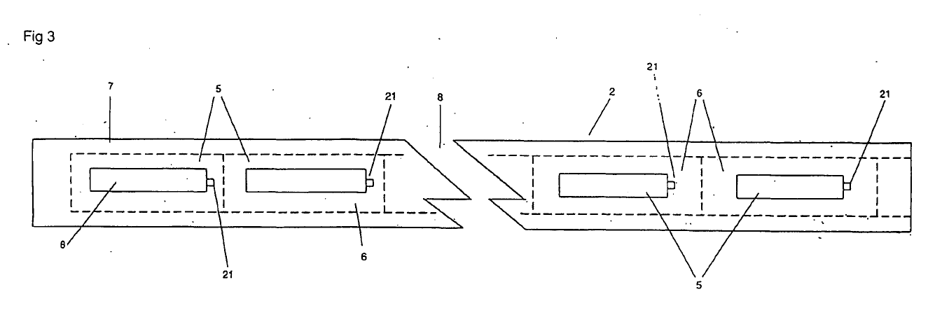

FIG. 3 shows a top plan view of a protective packaging system 11 formed in accordance with an alternative embodiment of the present invention. This system is essentially the same as that shown with respect to FIGS. 1a and 1b but includes in addition a handling tab 21 underneath each bandage 5.

The handling tab is sandwiched between the lower length of the protective strip and a bandage to separate an adhesive coated area of the bandage from the strip. The tap 21 protrudes out from under the edge of the bandage providing a surface or edge which a user may grasp to pull the adhesive coated bandage from the protective strip.

This handling tab can also be used to assist in the placement of the adhesive bandage on a wound to be dressed. A user can position the bandage with use of the handling tab 21 without needing to place their fingers in contact with the adhesive coated portions of the bandage.

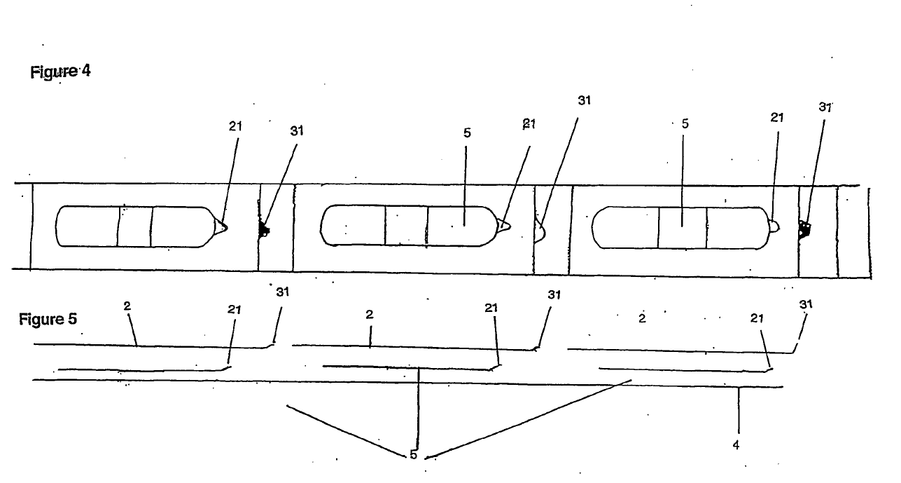

FIGS. 4 and 5 show a top and side exploded side view of a protective packaging system formed in accordance with yet another alternative embodiment for that shown with respect to FIGS. 1a, 1b, 2 and 3.

The main difference between the protective packaging systems discussed above and those discussed with respect to FIGS. 4 and 5 is the provision of a plurality of distinct or discreet upper strips 32, provided to implement the upper length of material. Each of these strips is used to cover one bandage only and also includes a protrusion 31 or pull-tab which is not connected to the lower strip. These pull-tabs can be employed by a user to pull an upper strip off the lower length, and thereby easily access the bandage contained.

Aspects of the present invention have been described by way of example only and it should be appreciated that modifications and additions may be made thereto without departing from the scope thereof as defined in the appended claims.

What I claim is:

1. A protective packaging system which includes,
a strip of protective material adapted to form a plurality of internal cavities, said cavities being used to house articles to be packaged.

2. A protective packaging system as claimed in claim 1 wherein the strip is formed from an upper length and a lower length bonded together at selected areas to form said plurality of internal cavities.

3. A protective packaging system as claimed in claim 1 or claim 2 wherein a single bandage is packaged within each internal cavity of the strip of protective material.

4. A protective packaging system as claimed in claim 3 wherein a single adhesive strip bandage is packaged within each internal cavity of the strip of protective material.

5. A protective packaging system as claimed in any previous claim wherein each internal cavity provides an airtight environment.

6. A protective packaging system as claimed in any previous claim wherein each internal cavity provides a sterile environment.

7. A protective packaging system as claimed in any previous claim wherein said strip of protective material is formed from one or more lengths of paper material.

8. A protective packaging system as claimed in any one of claims 1 to 6 wherein said strip of protective material is formed from one or more lengths of plastic film.

9. A protective packaging system as claimed in any previous claim wherein said strip of protective material includes at least one additive.

10. A protective packaging system as claimed in claim 9 wherein the additive improves the protective material's impermeability to gas or fluids.

11. A protective packaging system as claimed in claim 9 wherein the additive provides a sterilising compound.

12. A protective packaging system as claimed in any one of claims 2 to 11 wherein the upper and lower lengths of the strip are formed from two substantially continuous lengths of material.

13. A protective packaging system as claimed in any one of claims 2 to 11 wherein the lower length of the strip is formed from a substantially continuous length of material and the upper strip is formed from a plurality of discreet portions placed over each bandage to be packaged.

14. A protective packaging system as claimed in claim 13 wherein each portion of the upper strip includes a pull tab extending from one side of said portion.

15. A protective packaging system as claimed in any one of claims 2 to 14 where adhesive is applied longitudinally to one surface of each length along the sides of each length.

16. A protective packaging system as claimed in any one of claims 2 to 15 where an adhesive is applied in a plurality of transverse applications to one surface of each length.

17. A protective packaging system as claimed in any one of claims 15 or 16 wherein the adhesive selected allows the upper and lower lengths of the strip to be disengaged when force is applied to separate said lengths.

18. A protective packaging system as claimed in any one of claims 2 to 17 wherein each bandage packaged includes a handling tab.

19. A protective packaging system as claimed in claim 18 wherein a handling tab is sandwiched between an adhesive coated portion of a bandage and a length of material adapted to form a portion of said strip of protective material.

20. A protective packaging system as claimed in any one of claims 18 or 19 wherein said handling tag protrudes out past one side of a bandage when located on a length of the strip of protective material.

21. A protective packaging system as claimed in any one of claims 1 through 20 wherein the strip is wound into a roll located within a dispensing box, said dispensing box being formed so that extraction of the strip from the box will cause the internal cavities of the strip to be opened.

22. A protective packaging system substantially as herein described with reference to and as illustrated by the accompanying drawings and/or examples.

23. A wound dressing system substantially as herein described with reference to and as illustrated by the accompanying drawings and/or examples.

24. A method of manufacturing and using a protective packaging system substantially as herein described with reference to and as illustrated by the accompanying drawings and/or examples.

25. A method of manufacturing and using a wound dressing system substantially as herein described with reference to and as illustrated by the accompanying drawings and/or examples.
